(19) United States
(12) Patent Application Publication
(10) Pub. No.: US 2023/0252772 A1
(43) Pub. Date: Aug. 10, 2023

(54) METHOD AND SYSTEM FOR EVALUATING PERFORMANCE OF IMAGE TAGGING MODEL

(71) Applicant: NAVER CORPORATION, Seongnam-si (KR)

(72) Inventors: Hyung Do KIM, Seongnam-si (KR); Jaehoon JUNG, Seongnam-si (KR); Hyunyang SEO, Seongnam-si (KR)

(21) Appl. No.: 18/165,022

(22) Filed: Feb. 6, 2023

(30) Foreign Application Priority Data
Feb. 7, 2022 (KR) 10-2022-0015801

(51) Int. Cl. G06V 10/776; G06V 20/70; G06V 10/764

(52) U.S. Cl. CPC G06V 10/776; G06V 10/764; G06V 20/70

(57) ABSTRACT

A method for comparing and evaluating performance of an image tagging model includes receiving a verification data set including a plurality of verification images and a plurality of correct values associated with the plurality of verification images, receiving a first image tagging model and a second image tagging model, calculating a first performance score for the first image tagging model using the verification data set, and calculating a second performance score for the second image tagging model using the verification data set, in which each of the correct values is associated with at least one verification class of a verification class set.

### CROSS-REFERENCE TO RELATED APPLICATIONS

This application claims priority to Korean Patent Application No. 10-2022-0015801, filed in the Korean Intellectual Property Office on Feb. 7, 2022, the entire contents of which are hereby incorporated by reference.

### BACKGROUND OF THE INVENTION

### Field of Invention

The present disclosure relates to a method and a system for comparing and evaluating performance of an image tagging model, and specifically, to a method and a system for objectively evaluating performance scores of image tagging models outputting different label sets according to a unified criterion, using the same verification data set and without additional training.

### Description of Related Art

An image tagging model may refer to a model configured to receive an input image and output a label for the input image. The label may indicate meaningful information related to the image, such as information on an object included in the image, information on a background included in the image, information on a situation depicted by the image, and the like. In general, the output labels of the image tagging model may be determined by the training data. That is, the image tagging model may output only the labels included in the training data.

A verification data set may be used to measure the performance of the image tagging model. For example, the performance of the image tagging model may be measured by comparing, with correct values, output values of the verification image obtained by inputting the verification image to the image tagging model. In this case, if the image tagging model is not trained using the training data having the same label set as the verification data set, the label set included in the output value and the label set included in the correct value are different from each other, and as a result, the performance of the image tagging model cannot be accurately measured by comparing the output value with the correct value. Accordingly, in the related art, there is a problem in that it is necessary to previously re-train the image tagging model using the training data having the same label set as the verification data set and measure the performance, in order to evaluate the performance of the image tagging model.

In particular, the above problem is more prominent when comparing and evaluating several models. In order to compare and evaluate a plurality of models to determine which model has better performance, it is necessary to evaluate with the same criterion. However, in order to compare and evaluate the performance of a plurality of image tagging models trained by the training data with different label sets by using the same verification data set, it is necessary to go through the cumbersome process of re-training all the image tagging models with the verification data set and evaluating each model.

### BRIEF SUMMARY OF THE INVENTION

In order to address one or more problems (e.g., the problems described above and/or other problems not explicitly described herein), the present disclosure provides a method for, a non-transitory computer-readable recording medium storing instructions for, and an apparatus (system) for comparing and evaluating performance of an image tagging model.

The present disclosure may be implemented in a variety of ways, including a method, an apparatus (system), or a non-transitory computer-readable recording medium storing instructions.

A method for comparing and evaluating performance of an image tagging model is provided, which may be performed by one or more processors and include receiving a verification data set including a plurality of verification images and a plurality of correct values associated with the plurality of verification images, receiving a first image tagging model and a second image tagging model, calculating a first performance score for the first image tagging model using the verification data set, and calculating a second performance score for the second image tagging model using the verification data set, in which each of the correct values may be associated with at least one verification class of a verification class set.

There is provided a non-transitory computer-readable recording medium storing instructions for executing the method on a computer.

An information processing system is provided, which may include a memory; and one or more processors connected to the memory and configured to execute one or more computer-readable programs included in the memory, in which the one or more programs may include instructions for receiving a verification data set including a plurality of verification images and a plurality of correct values associated with the plurality of verification images, receiving a first image tagging model and a second image tagging model, calculating a first performance score for the first image tagging model using the verification data set, and calculate a second performance score for the second image tagging model using the verification data set, and each of the correct values may be associated with at least one verification class of a verification class set.

According to some examples of the present disclosure, the performance of the image tagging model may be objectively evaluated and compared without additional training, by using the verification data set having the verification class set different from the label set associated with the image tagging model.

According to some examples of the present disclosure, the quantitative performances of a plurality of image tagging models having different label sets can be compared and evaluated using the same verification data set and without additional training.

The effects of the present disclosure are not limited to the effects described above, and other effects not described herein can be clearly understood by those of ordinary skill in the art from the description of the claims.

### BRIEF DESCRIPTION OF THE DRAWINGS

The above and other objects, features and advantages of the present disclosure will be described with reference to the accompanying drawings described below, where similar reference numerals indicate similar elements, but not limited thereto, in which:

FIG. 1 is a diagram illustrating an example of a method for measuring a performance score of an image tagging model;

FIG. 2 schematically illustrates a configuration in which an information processing system is communicatively connected to a plurality of user terminals;

FIG. 3 is a block diagram of an internal configuration of the user terminal and the information processing system;

FIG. 4 is a diagram illustrating an example of a verification data set;

FIG. 5 is a diagram illustrating an example of an output value of an image tagging model;

FIG. 6 is a diagram illustrating an example of a method for calculating a performance score of each label for a verification class;

FIG. 7 is a diagram illustrating an example of calculating a performance score of each label for a verification class;

FIG. 8 is a diagram illustrating an example of calculating a performance score of each label for the verification class to map a verification class and a label;

FIG. 9 is a diagram illustrating an example of converting an output of the image tagging model using a label-verification class mapping table;

FIG. 10 is a diagram illustrating an example of comparing and evaluating performance of image tagging models; and

FIG. 11 is a flowchart illustrating an example of a method for comparing and evaluating the performance of an image tagging model.

### DETAILED DESCRIPTION OF THE INVENTION

Hereinafter, example details for the practice of the present disclosure will be described in detail with reference to the accompanying drawings. However, in the following description, detailed descriptions of well-known functions or configurations will be omitted if it may make the subject matter of the present disclosure unclear.

In the accompanying drawings, the same or corresponding components are assigned the same reference numerals. In addition, in the following description of various examples, duplicate descriptions of the same or corresponding components may be omitted. However, even if descriptions of components are omitted, it is not intended that such components be excluded in any example.

Advantages and features of the disclosed examples and methods of accomplishing the same will be apparent by referring to examples described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The terms used herein will be briefly described prior to describing the disclosed example(s) in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, and the meaning of the terms will be described in detail in a corresponding description of the example(s). Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, if a portion is stated as “comprising (including)” a component, it intends to mean that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or included in one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

The “module” or “unit” may be implemented as a processor and a memory. The “processor” should be interpreted broadly to encompass a general-purpose processor, a central processing unit (CPU), a microprocessor, a digital signal processor (DSP), a controller, a microcontroller, a state machine, and so forth. Under some circumstances, the “processor” may refer to an application-specific integrated circuit (ASIC), a programmable logic device (PLD), a field-programmable gate array (FPGA), and so on. The “processor” may refer to a combination for processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and so on. The memory is said to be in electronic communication with a processor if the processor can read information from and/or write information to the memory. The memory integrated with the processor is in electronic communication with the processor.

In the present disclosure, a “system” may refer to at least one of a server device and a cloud device, but not limited thereto. For example, the system may include one or more server devices. In another example, the system may include one or more cloud devices. In still another example, the system may include both the server device and the cloud device operated in conjunction with each other.

In the present disclosure, the “machine learning model” may include any model that is used for inferring an answer to a given input. The machine learning model may include an artificial neural network model including an input layer, a plurality of hidden layers, and an output layer. Each layer may include a plurality of nodes.

In the present disclosure, a “display” may refer to any display device associated with a computing device, and for example, it may refer to any display device that is controlled by the computing device, or that can display any information/data provided from the computing device.

In the present disclosure, “each of a plurality of A” may refer to each of all components included in the plurality of A.

In the present disclosure, an “A set” may refer to a set including at least one A.

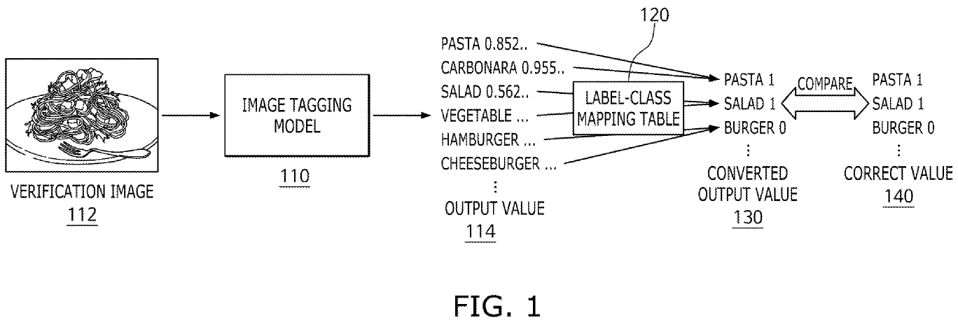

FIG. 1 is a diagram illustrating an example of a method for measuring a performance score of an image tagging model 110. The image tagging model 110 may be a model configured to receive an image as an input, and output an output a value for the input image The output value for the input image may be associated with one or more labels. In this case, the label may indicate information related to the image. For example, the label may indicate meaningful information related to the image, such as information on an object included in the image, information on a background included in the image, information on a situation described by the image, and the like. That is, the image tagging model 110 may be a model that analyzes an input image and provides information related to the image.

The output value of the image tagging model 110 may have various forms. For example, the image tagging model 110 may output a confidence value for each of one or more labels as an output value. As another example, for each of the one or more labels, the image tagging model 110 may output ‘1’ as an output value if the confidence value is greater than or equal to a predetermined threshold value (e.g., 0.7) and output ‘0’ as an output value if the confidence value is less than the predetermined threshold value. As another example, the image tagging model 110 may output one label having the highest confidence value as an output value, or output one or more labels having the confidence value equal to or greater than a predetermined threshold value as output values. In the present disclosure, the “output values” of the image tagging model 110 may refer to various forms of output values as described above.

The image tagging model 110 may be a machine learning model trained using training data. In general, a label associated with the output value output by the image tagging model 110 corresponds to at least one label of a label set associated with the training data used for training the image tagging model 110. That is, the image tagging model 110 may output only a label included in the label set associated with the training data.

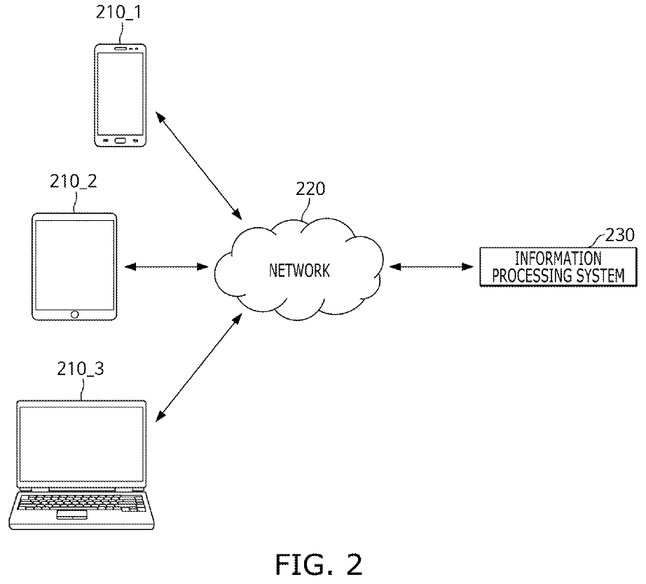

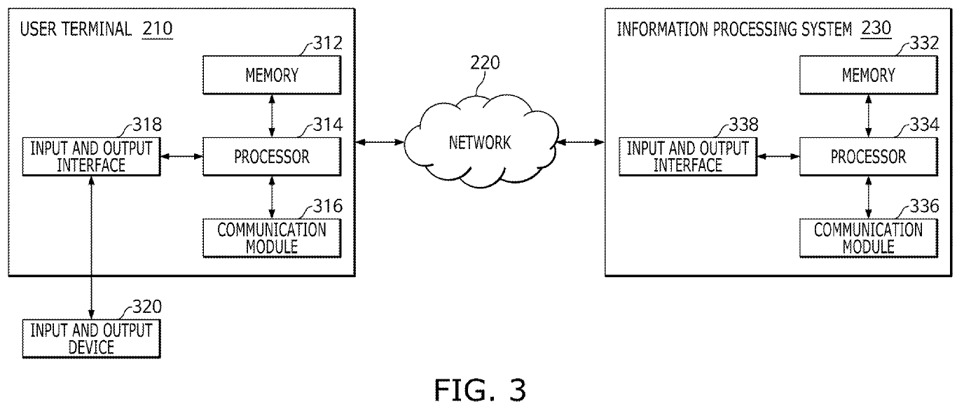

In order to evaluate the performance of the image tagging model 110, the information processing system 230 (Shown in FIGS. 2 and 3) may measure a performance score of the image tagging model 110 using a verification data set. For example, by comparing an output value 114 of a verification image 112, which is output as a result of inputting the verification image 112 to the image tagging model 110, with a correct value (Ground Truth value) 140 associated with the verification image, a performance score of the image tagging model 110 may be measured. The information processing system may repeat this process for various verification images.

An example of the image tagging model 110 is illustrated in FIG. 1. As illustrated, the image tagging model 110 may output a confidence value for each of the labels such as “Pasta,” “Carbonara,” “Salad,” and the like, as the output value 114 for the verification image 112. That is, the image tagging model 110 illustrated in the drawing may be a model trained using training data having a label set including “Pasta,” “Carbonara,” “Salad,” and the like. Meanwhile, as illustrated, the correct value 140 for the verification image may be a binary value (0 or 1) for each of the labels such as “Pasta,” “Salad,” “Burger,” and the like. In this case, since the label set associated with the output value 114 is different from the label set associated with the correct value 140, the performance score cannot be measured by directly comparing the output value 114 with the correct value 140. In cases where the label set associated with the output value 114 and the label set associated with the correct value 140 are different from each other as shown in the example of FIG. 1, in order to evaluate the performance of the image tagging model 110 using prior art, a cumbersome process is required, in which the image tagging model 110 should be re-trained using the training data associated with the correct value 140 before evaluating the performance of the image tagging model 110.

By mapping the label set included in the output value 114 to the label set included in the correct value 140, even when the label set associated with the output value 114 and the label set associated with the correct value 140 are different, the information processing system can quantitatively evaluate the performance of the image tagging model 110 without additional training. Hereinafter, in order to clearly explain the embodiment of the disclosure, a label associated with the correct value 140 for the verification image and a label associated with the output value 114 output by the image tagging model 110 will be distinguished from each other by referring the label associated with the correct value 140 for the verification image as a “class” or a “verification class”.

The information processing system may map a label set associated with the output value 114 to a verification class set associated with the correct value 140 to generate a label-verification class mapping table 120. The label-verification class mapping table 120 may define a mapping relationship from the label set to the verification class set. For example, the label-verification class mapping table 120 may include information that the label “Pasta” is mapped to the class “Pasta,” the label “Carbonara” is mapped to the class “Pasta,” the label “Salad” is mapped to the class “Salad,” and the label “Vegetable” is mapped to the class “Salad,” and the like.

Using the label-class mapping table 120, the information processing system may change each label included in the output value 114 for the verification image to the mapped verification class, thereby generating a converted output value 130. The information processing system may compare the converted output value 130 with the correct value 140 to quantitatively measure the performance score of the image tagging model 110.

As described above, the information processing system may map the label set associated with the output value 114 to the verification class set associated with the correct value 140 to evaluate the performance of any image tagging model without additional training. In addition, the performances of a plurality of image tagging models having different label sets from each other may be compared and evaluated according to the same criterion using the same verification data set.

The process of evaluating the performance of the image tagging model 110 has been described above as being performed by the information processing system, but aspects of the process are not limited thereto, and accordingly, it may be performed by various computing devices such as a user terminal, a separate cloud device, and the like, or may be performed by the user terminal and the information processing system in distributed manner. However, for convenience of description, it is assumed herein that the process of evaluating the performance of the image tagging model 110 is performed by the information processing system.

FIG. 2 schematically illustrates a configuration in which an information processing system 230 is communicatively connected to a plurality of user terminals 210_1, 210_2, and 210_3. As illustrated, the plurality of user terminals 210_1, 210_2, and 210_3 may be connected through a network 220 to the information processing system 230 that is capable of providing a service for evaluating performance of the image tagging model 110. In this example, the plurality of user terminals 210_1, 210_2, and 210_3 may include terminals of users (e.g., a developer of the image tagging model, and the like) to be provided with the service for evaluating performance of the image tagging model 110. The information processing system 230 may include one or more server devices and/or databases, or one or more distributed computing devices and/or distributed databases based on cloud computing services that can store, provide and execute computer-executable programs (e.g., downloadable applications) and data relating to the service for evaluating performance of the image tagging model and the like.

The service for evaluating performance of the image tagging model 110 provided by the information processing system 230 may be provided to the user through an application, a web browser, or the like for evaluating performance of the image tagging model 110, which may be installed in each of the plurality of user terminals 210_1, 210_2, and 210_3. For example, through the application or the like for evaluating performance of the image tagging model 110, the information processing system 230 may provide corresponding information or perform corresponding process according to a request to evaluate performance of the image tagging model 110 received from the user terminals 210_1, 210_2, and 210_3.

The plurality of user terminals 210_1, 210_2, and 210_3 may communicate with the information processing system 230 through the network 220. The network 220 may be configured to enable communication between the plurality of user terminals 210_1, 210_2, and 210_3 and the information processing system 230. The network 220 may be configured as a wired network such as Ethernet, a wired home network (Power Line Communication), a telephone line communication device and RS-serial communication, a wireless network such as a mobile communication network, a wireless LAN (WLAN), Wi-Fi, Bluetooth, and ZigBee, or a combination thereof, depending on the installation environment. The method of communication may include a communication method using a communication network (e.g., mobile communication network, wired Internet, wireless Internet, broadcasting network, satellite network, and the like) that may be included in the network 220 as well as short-range wireless communication between the user terminals 210_1, 210_2, and 210_3, but aspects of the communication method are not limited thereto.

In FIG. 2, a mobile phone terminal 210_1, a tablet terminal 210_2, and a PC terminal 210_3 are illustrated as the examples of the user terminals, but aspects of the terminals are not limited thereto, and the user terminals 210_1, 210_2, and 210_3 may be any computing device that is capable of wired and/or wireless communication and that can be installed with the application, the web browser, or the like for evaluating performance of the image tagging model and execute the same. For example, the user terminal may include an Al speaker, a smart phone, a mobile phone, a navigation, a computer, a notebook, a digital broadcasting terminal, a personal digital assistant (PDA), a portable multimedia player (PMP), a tablet PC, a game console, a wearable device, an internet of things (IoT) device, a virtual reality (VR) device, an augmented reality (AR) device, a set-top box, and so on. In addition, while FIG. 2 illustrates that three user terminals 210_1, 210_2, and 210_3 are in communication with the information processing system 230 through the network 220, aspects of the user terminals are not limited thereto, and a different number of user terminals may be configured to be in communication with the information processing system 230 through the network 220.

The information processing system 230 may receive a plurality of image tagging models from the user terminals 210_1, 210_2, and 210_3. The information processing system 230 may measure the performance scores of the received plurality of image tagging models and provide them to the user terminals 210_1, 210_2, and 210_3. In this example, the information processing system 230 may measure the performance scores of the first image tagging model and the second image tagging model using the same verification data set so as to provide information for objectively comparing and evaluating the performances of the two models.

FIG. 3 is a block diagram of an internal configuration of the user terminal 210 and the information processing system 230. The user terminal 210 may refer to any computing device that is capable of executing the application, the web browser, or the like for evaluating performance of the image tagging model and capable of wired/wireless communication, and may include the mobile phone terminal 210_1, the tablet terminal 210_2, the PC terminal 210_3, and the like of FIG. 2, for example. As illustrated, the user terminal 210 may include a memory 312, a processor 314, a communication module 316, and an input and output interface 318. Likewise, the information processing system 230 may include a memory 332, a processor 334, a communication module 336, and an input and output interface 338. As illustrated in FIG. 3, the user terminal 210 and the information processing system 230 may be configured to communicate information and/or data through the network 220 using respective communication modules 316 and 336. In addition, an input and output device 320 may be configured to input information and/or data to the user terminal 210 or output information and/or data generated from the user terminal 210 through the input and output interface 318.

The memories 312 and 332 may include any non-transitory computer-readable recording medium. The memories 312 and 332 may include a permanent mass storage device such as random access memory (RAM), read only memory (ROM), disk drive, solid state drive (SSD), flash memory, and so on. As another example, a non-destructive mass storage device such as ROM, SSD, flash memory, disk drive, and so on may be included in the user terminal 210 or the information processing system 230 as a separate permanent storage device that is distinct from the memory. In addition, an operating system and at least one program code (e.g., a code for the application, and the like for evaluating performance of the image tagging model that is installed and driven in the user terminal 210) may be stored in the memories 312 and 332.

These software components may be loaded from a computer-readable recording medium separate from the memories 312 and 332. Such a separate computer-readable recording medium may include a recording medium directly connectable to the user terminal 210 and the information processing system 230, and may include a computer-readable recording medium such as a floppy drive, a disk, a tape, a DVD/CD-ROM drive, a memory card, and so on, for example. As another example, the software components may be loaded into the memories 312 and 332 through the communication modules 316 and 336 rather than the computer-readable recording medium. For example, at least one program may be loaded into the memories 312 and 332 based on a computer program installed by files provided by developers or a file distribution system that distributes an installation file of an application via the network 220.

The processors 314 and 334 may be configured to process the instructions of the computer program by performing basic arithmetic, logic, and input and output operations. The instructions may be provided to the processors 314 and 334 from the memories 312 and 332 or the communication modules 316 and 336. For example, the processors 314 and 334 may be configured to execute the received instructions according to a program code stored in a recording device such as the memories 312 and 332.

The communication modules 316 and 336 may provide a configuration or function for the user terminal 210 and the information processing system 230 to communicate with each other through the network 220, and may provide a configuration or function for the user terminal 210 and/or the information processing system 230 to communicate with another user terminal or another system (e.g., a separate cloud system or the like). For example, a request or data (e.g., a request to evaluate performance of the image tagging model, and the like) generated by the processor 314 of the user terminal 210 according to the program code stored in the recording device such as the memory 312 or the like may be transmitted to the information processing system 230 via the network 220 under the control of the communication module 316. Conversely, a control signal or a command provided under the control of the processor 334 of the information processing system 230 may be received by the user terminal 210 through the communication module 316 of the user terminal 210 through the communication module 336 and the network 220. For example, the user terminal 210 may receive a performance score obtained by evaluating the performance of the image tagging model from the information processing system 230 through the communication module 316.

The input and output interface 318 may be a means for interfacing with the input and output device 320. As an example, the input device of the input and output device 320 may include a device such as a camera including an audio sensor and/or an image sensor, a keyboard, a microphone, a mouse, and so on, and the output device of the input and output device 320 may include a device such as a display, a speaker, a haptic feedback device, and so on. As another example, the input and output interface 318 may be a means for interfacing with a device such as a touch screen or the like that integrates a configuration or function for performing inputting and outputting. For example, when the processor 314 of the user terminal 210 processes the instructions of the computer program loaded into the memory 312, a service screen or the like, which is configured with the information and/or data provided by the information processing system 230 or another user terminals, may be displayed on the display via the input and output interface 318. While FIG. 3 illustrates that the input and output device 320 is not included in the user terminal 210, aspects of the input and output device 320 are not limited thereto, and an input and output device may be configured as one device with the user terminal 210. In addition, the input and output interface 338 of the information processing system 230 may be a means for interfacing with a device (not illustrated) for inputting or outputting data that may be connected to, or included in the information processing system 230. While FIG. 3 illustrates the input and output interfaces 318 and 338 as the components configured separately from the processors 314 and 334, aspects of the input and output interfaces 318 and 338 are not limited thereto, and the input and output interfaces 318 and 338 may be configured to be included in the processors 314 and 334.

The user terminal 210 and the information processing system 230 may include more components than those illustrated in FIG. 3. However, known components need not be illustrated. The user terminal 210 may be implemented to include at least a part of the input and output device 320 described above. In addition, the user terminal 210 may further include other components such as a transceiver, a Global Positioning System (GPS) module, a camera, various sensors, a database, and the like. For example, if the user terminal 210 is a smartphone, it may include components generally included in the smartphone. For example, various components such as an acceleration sensor, a gyro sensor, a camera module, various physical buttons, buttons using a touch panel, input and output ports, a vibrator for vibration, and so on may be further included in the user terminal 210. The processor 314 of the user terminal 210 may be configured to operate the application, or the like for evaluating performance of the image tagging model. A code associated with the application and/or program may be loaded into the memory 312 of the user terminal 210.

While a program for the application or the like for evaluating performance of the image tagging model is being operated, the processor 314 may receive text, image, video, audio, and/or action, and so on inputted or selected through the input device such as a camera, a microphone, and so on, that includes a touch screen, a keyboard, an audio sensor and/or an image sensor connected to the input and output interface 318, and store the received text, image, video, audio, and/or action, and so on in the memory 312, or provide the same to the information processing system 230 through the communication module 316 and the network 220. For example, the processor 314 may receive an input indicating selections made by the user to the image tagging model and the like to be evaluated for performance and provide the received input to the information processing system 230 through the communication module 316 and the network 220. As another example, the processor 314 may receive an input indicating the selections made by the user to the verification data set and the like used for the evaluation of performance, and provide the received input to the information processing system 230 through the communication module 316 and the network 220.

The processor 314 of the user terminal 210 may be configured to manage, process, and/or store the information and/or data received from the input and output device 320, another user terminal, the information processing system 230 and/or a plurality of external systems. The information and/or data processed by the processor 314 may be provided to the information processing system 230 via the communication module 316 and the network 220. The processor 314 of the user terminal 210 may transmit the information and/or data to the input and output device 320 via the input and output interface 318 to output the same. For example, the processor 314 may display the received information and/or data on a screen of the user terminal.

The processor 334 of the information processing system 230 may be configured to manage, process, and/or store information and/or data received from the plurality of user terminals 210 and/or a plurality of external systems. The information and/or data processed by the processor 334 may be provided to the user terminals 210 via the communication module 336 and the network 220. The processor 334 of the information processing system 230 may measure the performance score of the received image tagging model based on the request to evaluate performance of the image tagging model received from the plurality of user terminals 210 and provide the result to the user terminals 210.

The processor 334 of the information processing system 230 may be configured to output the processed information and/or data through the input and output device 320 such as a device (e.g., a touch screen, a display, and so on) of the user terminals 210 capable of outputting a display, a device (e.g., a speaker) of the user terminals 210 capable of outputting an audio, and the like. For example, the processor 334 of the information processing system 230 may be configured to provide performance evaluation information (e.g., performance score) of the image tagging model to the user terminals 210 through the communication module 336 and the network 220, and output the performance evaluation information through the device of the user terminal 210 capable of output a display, or the like.

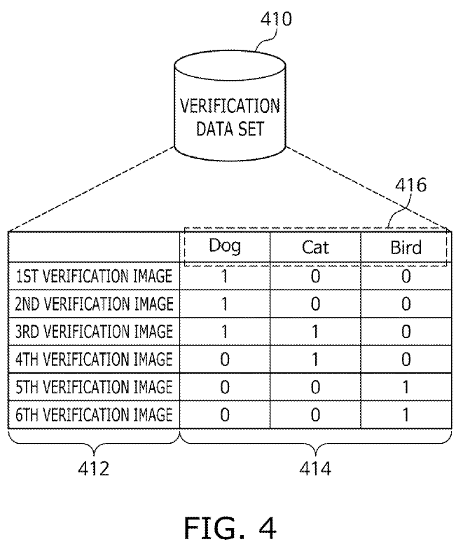

FIG. 4 is a diagram illustrating an example of a verification data set 410. The information processing system may receive the verification data set 410 and evaluate the performance of the image tagging model using the verification data set 410. The verification data set 410 may be a data set for evaluating the performance of the image tagging model. The verification data set 410 may include a plurality of verification images 412 and a plurality of correct values 414 associated with the plurality of verification images. The correct value 414 may be associated with a verification class set 416, and the verification class set 416 may include one or more classes. For example, the correct value 414 may include a binary value (1 or 0) for each class included in the verification class set 416.

FIG. 4 illustrates a specific example of the verification data set 410. As illustrated, the verification data set 410 may include six verification images 412 and the correct value 414 associated with each verification image. In the illustrated example, the correct value 414 associated with the verification image may be associated with the verification class set 416 including three verification classes (“Dog” class, “Cat” class, and “Bird” class), and the correct value 414 associated with the verification image may include a binary value (1 or 0) for each class included in the verification class set 416. In the illustrated example, each class may represent information of an object included in the verification image 412, and 1 may represent Positive/True, and 0 may represent Negative/False. For example, the correct value associated with the first verification image is illustrated as [1 0 0], which may indicate that a Dog object is included in the first verification image, and the correct value associated with the third verification image is illustrated as [1 1 0], which may indicate that a Dog object and a Cat object are included in the third verification image.

FIG. 4 illustrates that the verification data set 410 includes six verification images and is associated with three verification classes for convenience of description, but aspects of the verification data set 410 are not limited thereto. The verification data set 410 may include any number of verification images and may be associated with any number of verification classes.

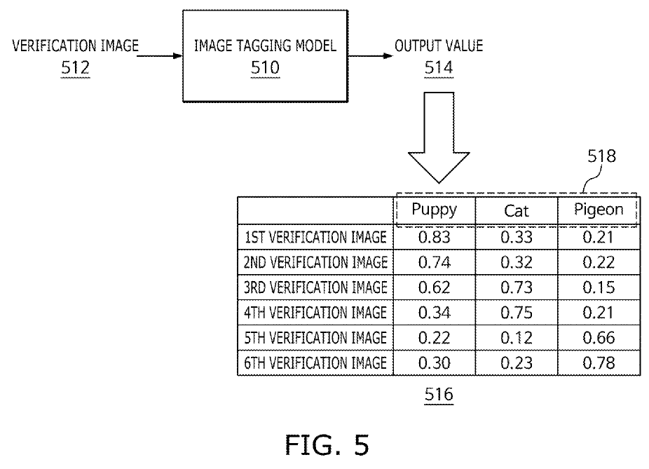

FIG. 5 is a diagram illustrating an example of an output value 514 of an image tagging model 510. In order to evaluate the performance of the image tagging model 510, the information processing system 230 may input a plurality of verification images 512 included in the verification data set to the image tagging model 510 to generate an output value set 516. In this case, the output value set 516 may be associated with a label set 518 that includes one or more labels. For example, each output value included in the output value set 516 may include a confidence value for each label included in the label set 518. The information processing system 230 may determine the label set 518 associated with the output value set 516 to be the label set 518 associated with the image tagging model 510.

FIG. 5 illustrates a specific example of the output value set 516 output as a result of inputting the plurality of verification images 512 to the image tagging model 510. In the illustrated example, the output value set 516 may be associated with the label set 518 that includes a “Puppy” label, a “Cat” label, and a “Pigeon” label. Specifically, in the illustrated example, the output value 514 for the verification image 512 may include a confidence value for each label included in the label set 518. In the illustrated example, the information processing system 230 may determine the label set 518 including a “Puppy” label, a “Cat” label, and a “Pigeon” label to be the label set 518 associated with the image tagging model 510.

Meanwhile, in order to evaluate the performance of the image tagging model 510, it is necessary to compare the output value set 516 and the correct value set for the verification image 512, but if the label set 518 associated with the image tagging model 510 and the verification class set associated with the correct value set are different from each other, direct comparison between the output value set 516 and the correct value set is not possible. For example, the image tagging model 510 illustrated in FIG. 5 is associated with the label set 518 including the “Puppy” label, the “Cat” label, and the “Pigeon” label, but the correct value set 414 illustrated in FIG. 4 is associated with the verification class set 416 including the “Dog” class, the “Cat” class, and the “Bird” class, in which case a direct comparison between the two is impossible. Accordingly, the information processing system 230 may generate a label-verification class mapping table defining a mapping relationship from the label set 518 associated with the image tagging model 510 to the verification class set, and using the label-verification class mapping table, convert the output value of the image tagging model 510 so that it is associated with the verification class set.

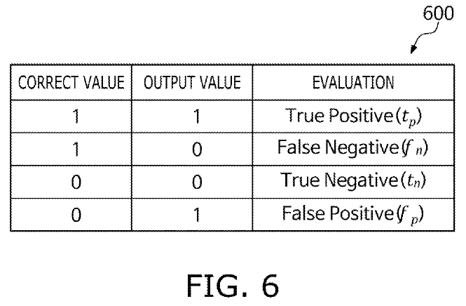

FIG. 6 is a diagram illustrating an example of a method for calculating a performance score of each label for the verification class. The information processing system 230 may generate a label-verification class mapping table based on the correct value set and the output value set. For example, the information processing system 230 may calculate a performance score of each label set for each verification class included in the verification class set, and map a label having the highest performance score for each verification class to the corresponding verification class. Alternatively, the information processing system 230 may map the labels having performance scores equal to or greater than a predetermined threshold value for each verification class to the corresponding verification class.

While various performance score calculation methods may be used to calculate the performance score of each label set for each verification class, the F1 score calculation method is described herein as an example. This is to explain a specific example for a clear understanding of the present disclosure, and accordingly, the scope of the present disclosure is not limited thereto, and various performance score calculation methods may be used.

First, in order to calculate the F1 score, both the correct value and the output value must have a binary value of 0 or 1. If the correct value and/or the output value does not have a value of 0 or 1, the information processing system 230 may convert the correct value and/or output value into a value of 0 or 1. For example, if the output value is a confidence value of 0 or more and 1 or less, the information processing system 230 may convert the output value into 1 if the output value is equal to or greater than a predefined threshold value, and convert the output value into 0 if the output value is less than the predefined threshold value.

The information processing system 230 may evaluate each output value included in the output value set according to an evaluation table 600 illustrated in FIG. 6. Each output value may be classified into four cases of True Positive, False Negative, True Negative, and False Positive according to the combination of the correct value and the output value, and the number of true positives, the number of false negatives, the number of true negatives, and the number of false positives included in the output value set may each be defined as tₚ,ƒₙ,tₙ,ƒₚ. The information processing system 230 may calculate precision and a recall rate using the tₚ,ƒₙ,tₙ,ƒₚ value. For example, the precision and the recall rate may be calculated by Equation 1 below.

$$\begin{matrix}P r e c i s i o n = \frac{{t}_{p}}{{t}_{p} + {f}_{p}} , & R e c a l l = \frac{{t}_{p}}{{t}_{p} + {f}_{n}}\end{matrix}$$

The information processing system 230 may calculate the F1 score using the calculated precision and recall rate. The F1 score may be calculated as a harmonic average of the precision and the recall rate, and weights of the precision and the recall rate may be determined according to the importance of the precision and the recall rate. For example, the F1 score having the same weights of the precision and recall rate may be calculated by Equation 2 below.

$$F = \frac{2 \times P r e c i s i o n \times R e c a l l}{P r e c i s i o n + R e c a l l}$$

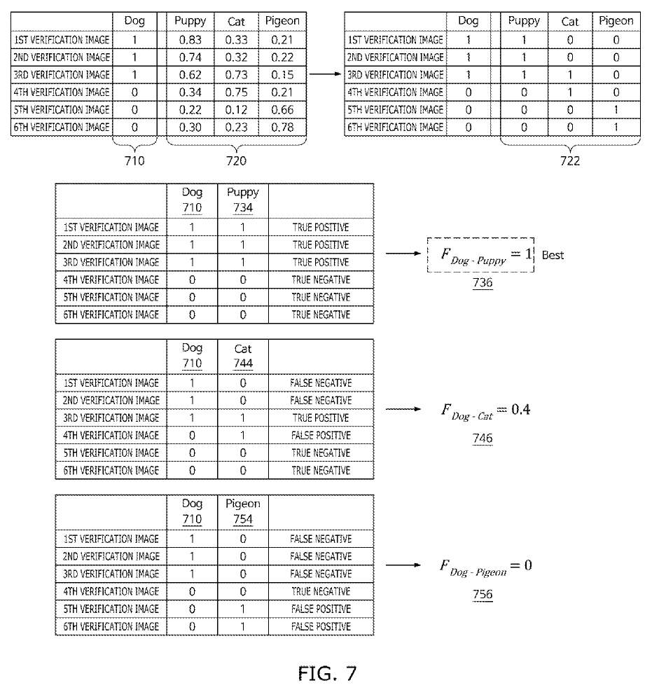

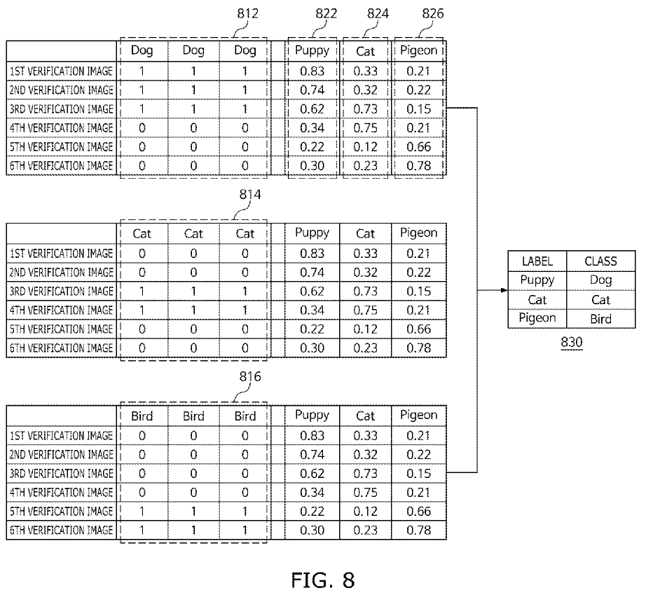

The process of calculating the performance score of each label set for each verification class by using the F1 score calculation method described above will be described below in detail with reference to FIGS. 7 and 8.

FIG. 7 is a diagram illustrating an example of calculating performance scores 736, 746, and 756 of each label for the verification class. The information processing system 230 may calculate the performance scores 736, 746, and 756 of each label set for each verification class included in the verification class set. The performance score of a particular label for a particular verification class may reflect the extent to which an output value associated with the particular label accurately matches the correct value associated with the particular verification class. FIG. 7 illustrates a process of calculating the performance scores 736, 746, and 756 of each of the three labels (“Puppy” label, “Cat” label, “Pigeon” label in FIG. 7) included in the label set for a certain verification class (hereinafter, the target verification class (“Dog” class in FIG. 7)).

In order to calculate the performance scores 736, 746, and 756 of each label according to the F1 score calculation method described above in FIG. 6, the information processing system 230 may convert the output values of an output value set 720 into a value of 0 or 1. For example, the information processing system 230 may convert the output value into 1 if the output value is equal to or greater than 0.6, and convert the output value into 0 if the output value is less than 0.6. In the following description of FIG. 7, the “output value set” may refer to an output value set 722 converted into 0 or 1.

The information processing system 230 may compare the correct values 710 associated with the target verification class with output values 734, 744, and 754 associated with respective labels of the output value set 722 to calculate the performance scores 736, 746, and 756 of each label for the target verification class. As a specific example, the information processing system 230 may compare the correct values 710 associated with the “Dog” class with the output values 734 associated with the “Puppy” label to calculate the performance score 736 of the “Puppy” label for the “Dog” class. In addition, the information processing system 230 may compare the correct values 710 associated with the “Dog” class with the output values 744 associated with the “Cat” label to calculate the performance score 746 of the “Cat” label for the “Dog” class, and compare the correct values 710 associated with the “Dog” class with the output values 754 associated with the “Pigeon” label to calculate the performance score 756 of the “Pigeon” label for the “Dog” class.

The information processing system 230 may map a label having the highest performance score for the target verification class to the target verification class. For example, the information processing system 230 may map the “Puppy” label having the highest performance score for the “Dog” class to the “Dog” class. According to another example, the information processing system 230 may map the labels having the performance score of a threshold value (e.g., 0.7) or higher for the target verification class to the target verification class. In this case, one or more labels may correspond to one verification class. Like calculating the performance scores 736, 746, and 756 of each of the label sets for the “Dog” class in FIG. 7, the performance scores of each of the label sets for the “Cat” class and the performance scores of each of the label sets for the “Bird” may be calculated.

FIG. 8 is a diagram illustrating an example of calculating the performance score of each label for the verification class to map the verification class and the label. The information processing system 230 may generate a label-verification class mapping table 830 defining a mapping relationship from the label set to the verification class set to calculate the performance score of the image tagging model. For example, the information processing system 230 may calculate the performance score of each label set for each verification class included in each verification class set, and map a label having the highest performance score for each verification class to each verification class.

FIG. 8 illustrates an example of generating the mapping table 830 defining the mapping relationship from the label set including three labels (“Puppy” label, “Cat” label, and “Pigeon” label) to the verification class set including three verification classes (“Dog” class, “Cat” class, and “Bird” class). For example, the information processing system 230 may compare the correct values 812 associated with the “Dog” class with output values 822 associated with the “Puppy” label, output values 824 associated with the “Cat” label, and output values 826 associated with the “Pigeon” label, respectively, to calculate the performance score of the “Puppy” label for the “Dog” class, the performance score of the “Cat” label for the “Dog” class, and the performance score of the “Pigeon” label for the “Dog” class, and map the “Puppy” label having the highest performance score for the “Dog” class among the labels, to the “Dog” class.

In addition, the information processing system 230 may compare the correct values 814 associated with the “Cat” class with the output values 822 associated with the “Puppy” label, the output values 824 associated with the “Cat” label, and the output values 826 associated with the “Pigeon” label, respectively, to calculate the performance score of the “Puppy” label for the “Cat” class, the performance score of the “Cat” label for the “Cat” class, and the performance score of the “Pigeon” label for the “Cat” class, and map the “Cat” label having the highest performance score for the “Cat” class among the labels, to the “Cat” class.

Likewise, the information processing system 230 may compare the correct values 816 associated with the “Bird” class with the output values 822 associated with the “Puppy” label, the output values 824 associated with the “Cat” label, and the output values 826 associated with the “Pigeon” label, respectively, to calculate the performance score of the “Puppy” label for the “Bird” class, the performance score of the “Cat” label for the “Bird” class, and the performance score of the “Pigeon” label for the “Bird” class, and map the “Pigeon” label having the highest performance score for the “Bird” class among the labels, to the “Bird” class.

The process of calculating the performance score of each label for each verification class may be performed in the same manner as or similarly to the process described above with reference to FIG. 7. The information processing system 230 may generate the label-verification class mapping table 830 defining a mapping relationship from the label set associated with the image tagging model to the verification class set through the mapping process described above. Referring to FIG. 8 and the description, it is illustrated and described that the label having the highest performance score for each verification class is mapped to each verification class, but aspects of mapping the label are not limited thereto, and labels having a performance score equal to or higher than a threshold value for each verification class may be mapped to each verification class. In addition, referring to FIG. 8 and the description, it is illustrated and described that the number of labels included in the label set is same as the number of verification classes included in the verification class set, but aspects of labels in the label set are not limited thereto, and the number of labels included in the label set may be different from the number of verification classes included in the verification class set, in which case the label-verification class mapping table 830 may still be generated by the process same as or similar to the process described above.

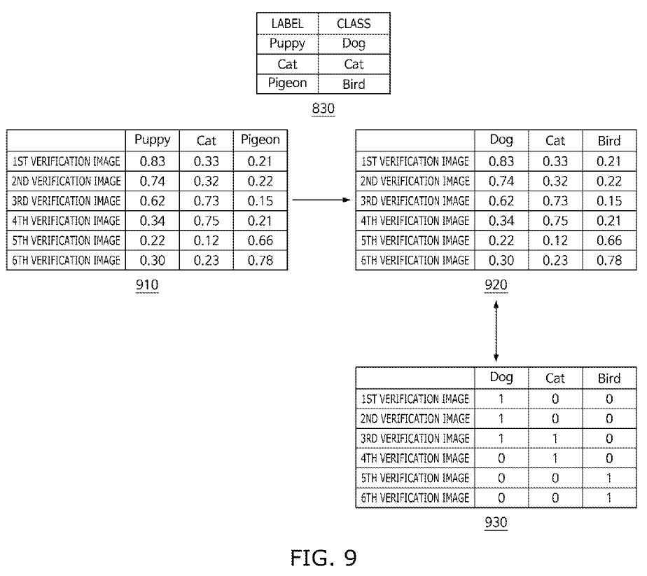

FIG. 9 is a diagram illustrating an example of converting an output of the image tagging model using the label-verification class mapping table 830. The information processing system 230 may convert the labels in an output value set 910 into verification classes using the label-verification class mapping table 830. FIG. 9 illustrates an example of converting the labels in the output value set 910 into the verification classes using the label-verification class mapping table 830 generated in FIG. 8. For example, the information processing system 230 may convert “Puppy” label, “Cat” label, and “Pigeon” label in the output value set 910 for a plurality of verification images into “Dog” class, “Cat” class, and “Bird” class, respectively, using the label-verification class mapping table 830. An output value set 920 converted as described above may be associated with the verification class set. That is, the converted output value set 920 may include output values for each verification class.

The information processing system 230 may compare the converted output value set 920 with a correct value set 930 to calculate a performance score of the image tagging model. In this case, the calculated performance score of the image tagging model may be a performance score standardized in terms of the verification class. In the illustrated example, since the image tagging model is associated with the label set including the “Puppy” label, the “Cat” label, and the “Pigeon” label, direct comparison evaluation with the correct value set 930 associated with the verification class set including the “Dog” class, the “Cat” class, and the “Bird” class is not possible, but using the label-verification class mapping table 830, it is possible to convert the labels in the output value set 910 into the verification classes, and direct comparative evaluation is possible and the performance score standardized in terms of the verification class can be calculated.

Referring to FIG. 9 and the description, it is described as an example that the labels and the verification classes correspond to each other on 1:1 basis, but aspects of mapping of the labels are not limited thereto, and there may be no verification class mapped to a particular label, or one label may be mapped to more than one verification classes, or one verification class may be mapped to more than one labels. For example, although FIG. 9 illustrates that the “Bird” class is mapped to the “Pigeon” label, if the “Bird” class corresponds to the “Puppy” label rather than the “Pigeon” label, there may be no class mapped to the “Pigeon” label, and the “Puppy” label may be mapped to the “Dog” class and the “Bird” class. In this case, in the output value set 910, the output value for the “Pigeon” label may be excluded from the performance score measurement of the image tagging model, and the output value for the “Puppy” label may be converted into an output value for the “Dog” class and an output value for the “Bird” class to measure the performance score of the image tagging model.

According to another example, if there is no verification class mapped to the “Pigeon” label as in the example described above, the verification class having the highest performance score of the “Pigeon” label among the verification classes may be mapped to the “Pigeon” label. If, among the performance scores of the “Pigeon” label for each verification class, the performance score of the “Pigeon” label for the “Cat” class is the highest, the “Pigeon” label and the “Cat” class may be mapped to each other. In the case of mapping the “Pigeon” label to the “Cat” class, the “Cat” class may be mapped to the “Cat” label and the “Pigeon” label, and in this case, from the output value set 910, an output value for the “Cat” label and an output value for the “Pigeon” label may be appropriately collected and converted into an output value for the “Cat” class. As a specific example, a weighted average of the output values for the “Cat” label and the output values for the “Pigeon” label may be calculated and converted into the output value for the “Cat” class.

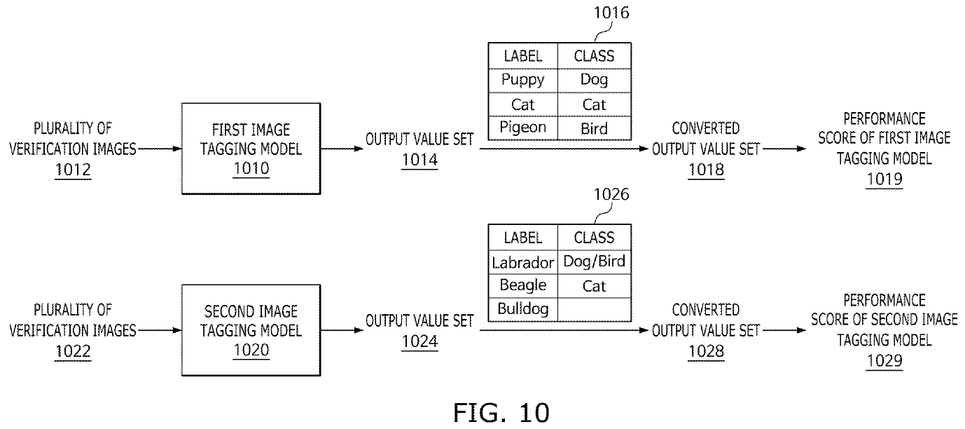

FIG. 10 is a diagram illustrating an example of comparing and evaluating the performance of image tagging models 1010 and 1020. The information processing system 230 may receive a first image tagging model 1010 and a second image tagging model 1020, and calculate a performance score 1019 of the first image tagging model and a performance score 1029 of the second image tagging model using the same verification data set.

The information processing system 230 may input a plurality of verification images 1012 included in the verification data set to the first image tagging model 1010 to generate an output value set 1014 for the plurality of verification images. The information processing system 230 may also input a plurality of verification images 1022 included in the verification data set to the second image tagging model 1020 to generate an output value set 1024 for the plurality of verification images. In this case, the plurality of verification images 1012 and the plurality of verification images 1024 may include the same images. A first label set associated with the first image tagging model 1010 and a second label set associated with the second image tagging model 1020 may be determined based on the output value sets 1014 and 1024 for the plurality of verification images. The first image tagging model 1010 and the second image tagging model 1020 may be models trained using different training data, and accordingly, the first label set associated with the first image tagging model 1010 and the second label set associated with the second image tagging model 1020 may be different from each other. As a specific example, in FIG. 10, the first image tagging model 1010 may be trained using the training data associated with the first label set including the “Puppy” label, the “Cat” label, and the “Pigeon” label, and may be associated with the first label set. Meanwhile, the second image tagging model 1020 may be trained using the training data associated with the second label set including a “Labrador” label, a “Beagle” label, and a “Bulldog” label, and may be associated with the second label set. In the illustrated example, the first label set and the second label set have the same number of labels, but aspects of the label are not limited thereto, and the number of labels included in each label set may be different from each other.

The information processing system 230 may generate label-verification class mapping tables 1016 and 1026 for each of the image tagging models 1010 and 1020, respectively, based on the correct values associated with the plurality of verification images included in the verification data set and the output value set 1014 and 1024 of each of the image tagging models 1010 and 1020, respectively. In addition, the information processing system 230 may convert the labels in the output value sets 1014 and 1024 into verification classes using the label-verification class mapping tables 1016 and 1026 for each of the image tagging models 1010 and 1020, respectively.

For example, in FIG. 10, the information processing system 230 may convert the “Puppy” label, the “Cat” label, and the “Pigeon” label in the output value set 1014 of the first image tagging model 1010 into the “Dog” class, the “Cat” class, and the “Bird” class, respectively, using the label-verification class mapping table 1016 for the first image tagging model. In addition, the information processing system 230 may convert the “Labrador” label in the output value set 1024 of the second image tagging model 1020 into the “Dog” class and the “Bird” class and convert the “Beagle” label into the “Cat” class, using the label-verification class mapping table 1026 for the second image tagging model. In the illustrated example, since the “Bulldog” label has no mapped verification class, among the output values in the output value set 1024 of the second image tagging model 1020, the output value for the “Bulldog” label may be excluded when calculating the performance score 1029 of the second image tagging model. As described above, the labels in the output value sets 1014 and 1024 are converted into the verification classes such that the converted output value sets 1018 and 1028 may be associated with at least one verification class of the verification class set.

The information processing system 230 may compare the correct values associated with the plurality of verification images included in the verification data set with the converted output value sets 1018 and 1028 of each of the image tagging models 1010 and 1020, respectively, to calculate the performance scores 1019 and 1029 of each of the image tagging models, 1010 and 1020, respectively. The calculated performance score 1019 of the first image tagging model 1010 and the performance score 1029 of the second image tagging model 1020 may be performance scores standardized in terms of verification classes. Based on this, the information processing system 230 may quantitatively compare and evaluate a difference in performance between the first image tagging model 1010 and the second image tagging model 1020.

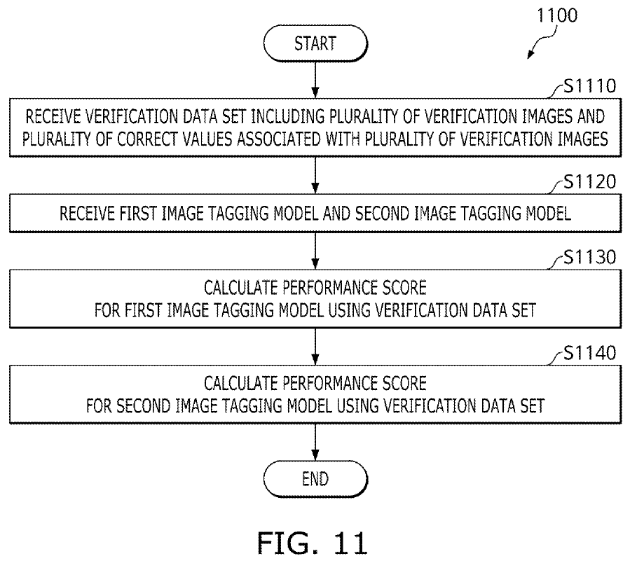

FIG. 11 is a flowchart illustrating an example of a method 1100 for comparing and evaluating the performance of the image tagging model. The method 1100 may be initiated by the processor 334 of the information processing system 230 receiving a verification data set including a plurality of verification images and a plurality of correct values associated with the plurality of verification images, at S1110. In this case, each correct value may be associated with at least one verification class of a predefined verification class set. The method 1100 may also be initiated by the processor 314 of the user terminal 210.

In addition, the processor 334 may receive the first image tagging model and the second image tagging model, at S1120. The first image tagging model and the second image tagging model may be models trained using different training data. Accordingly, the first image tagging model may be associated with the first label set, and the second image tagging model may be associated with the second label set different from the first label set. Further, the first label set associated with the first image tagging model and the second label set associated with the second image tagging model may include different numbers of labels, and the verification class set, the first label set, and the second label set may be different from each other.

The processor 314 may calculate a first performance score for the first image tagging model using the verification data set, at S1130. For example, the processor 314 may first determine the first label set associated with the first image tagging model. Specifically, the processor 314 may input a plurality of verification images to the first image tagging model to generate an output value set, and determine a first label set associated with the first image tagging model based on the output value set.

The processor 314 may generate a label-verification class mapping table defining a mapping relationship from the first label set to the verification data set. The processor 314 may calculate a performance score for each label set for each verification class, and map a label having the highest performance score for each verification class to the first verification class, or map the labels having a performance score equal to or greater than a threshold value for the first verification class to the first verification class so as to generate the label-verification class mapping table. For example, the processor 314 may compare the correct values associated with the first verification class with the output values in the output value set which are associated with the first label, to calculate a performance score of the first label for the first verification class, and perform this process for each label to map the label having the highest performance score for the first verification class or the labels having the performance score equal to or higher than the threshold value to the first verification class. In addition, the process for the first verification class described above is performed for each verification class included in the verification class set to generate a label-verification class mapping table defining a mapping relationship from the first label set to the verification data set.

The processor 314 may convert the output of the first image tagging model using the generated label-verification class mapping table. For example, the processor 314 may convert the labels in the output value set into the verification classes using the label-verification class mapping table. If there is a label in the first label set which is not mapped to the verification class, the corresponding label may be excluded when calculating the first performance score, or the corresponding label may be mapped to a specific verification class having the highest performance score. The processor 314 may calculate a first performance score standardized in terms of a verification class based on the converted output value set and the plurality of correct values.

In addition, the processor 314 may calculate a second performance score for the second image tagging model using the verification data set, at S1140. The process of calculating the second performance score for the second image tagging model by the processor 314 may be performed in the manner same as or similar to the process of calculating the first performance score for the first image tagging model described above.

The first performance score and the second performance score calculated at S1130 and S1140 may be the scores standardized in terms of the verification class, and the processor 314 may quantitatively compare and evaluate a difference in performance between the first image tagging model and the second image tagging model based on these scores.

The method described above may be provided as a computer program stored in a computer-readable recording medium for execution on a computer. The medium may be a type of medium that continuously stores a program executable by a computer, or temporarily stores the program for execution or download. In addition, the medium may be a variety of recording means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, and so on. In addition, other examples of the medium may include an app store that distributes applications, a site that supplies or distributes various software, and a recording medium or a storage medium managed by a server.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. A general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors, and may cause the processor(s) to perform certain aspects of the functions described in the present disclosure.

When implemented in software, the techniques may be stored on a computer-readable medium as one or more instructions or codes, or may be transmitted through a computer-readable medium. The computer-readable media include both the computer storage media and the communication media including any medium that facilitates the transmission of a computer program from one place to another. The storage media may also be any available media that may be accessed by a computer. By way of non-limiting example, such a computer-readable medium may include RAM, ROM, EEPROM, CD-ROM or other optical disk storage, magnetic disk storage or other magnetic storage devices, or any other media that can be used to transmit or store desired program code in the form of instructions or data structures and can be accessed by a computer. In addition, any connection is properly referred to as a computer-readable medium.

For example, if the software is sent from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer-readable media.

The software module may reside in RAM memory, flash memory, ROM memory, EPROM memory, EEPROM memory, registers, hard disk, removable disk, CD-ROM, or any other form of storage medium known. An exemplary storage medium may be connected to the processor such that the processor may read or write information from or to the storage medium. Alternatively, the storage medium may be integrated into the processor. The processor and the storage medium may exist in the ASIC. The ASIC may exist in the user terminal. Alternatively, the processor and storage medium may exist as separate components in the user terminal.

Although the examples disclosed above have been described as utilizing aspects of the currently disclosed subject matter in one or more standalone computer systems, the present invention may be implemented in conjunction with any computing environment, such as a network or distributed computing environment. Furthermore, the aspects of the subject matter in the present disclosure may be implemented in multiple processing chips or devices, and storage may be similarly influenced across a plurality of devices. Such devices may include PCs, network servers, and portable devices.

Although the present disclosure has been described in connection with some examples herein, various modifications and changes can be made without departing from the scope of the present disclosure, which can be understood by those skilled in the art to which the present disclosure pertains. In addition, such modifications and changes should be considered within the scope of the claims appended herein.

1. A method for comparing and evaluating performance of an image tagging model, the method being performed by one or more processors and comprising:
receiving a verification data set including a plurality of verification images and a plurality of correct values associated with the plurality of verification images;
receiving a first image tagging model and a second image tagging model;
calculating a first performance score for the first image tagging model using the verification data set; and
calculating a second performance score for the second image tagging model using the verification data set,
wherein each of the correct values is associated with at least one verification class of a verification class set.

2. The method according to claim 1, wherein the first performance score and the second performance score are scores standardized in terms of a verification class.

3. The method according to claim 1, wherein the calculating the first performance score includes:
inputting the plurality of verification images to the first image tagging model to generate an output value set; and
determining a first label set associated with the first image tagging model based on the output value set.

4. The method according to claim 3, wherein the calculating the first performance score further includes:
generating a label-verification class mapping table based on the plurality of correct values and the output value set; and
converting labels in the output value set into verification classes using the label-verification class mapping table.

5. The method according to claim 4, wherein the label-verification class mapping table defines a mapping relationship from the first label set to the verification class set.

6. The method according to claim 4, wherein the calculating the first performance score further includes calculating the first performance score standardized in terms of a verification class based on the converted output value set and the plurality of correct values.

7. The method according to claim 4, wherein the generating the label-verification class mapping table includes:
calculating a performance score of each of first labels in the first label set for a first verification class;
mapping a first label having a highest performance score for the first verification class to the first verification class;
calculating a performance score of each of the first labels in the first label set for a second verification class; and
mapping a second label having a highest performance score for the second verification class to the second verification class.

8. The method according to claim 7, wherein the calculating the performance score of each of the first labels in the first label set for the first verification class includes calculating a performance score of the first label for the first verification class by comparing correct values associated with the first verification class with output values in the output value set which are associated with the first label.

9. The method according to claim 4, wherein the generating the label-verification class mapping table includes:
calculating a performance score of each of first labels in the first label set for a first verification class;
mapping labels having performance scores equal to or greater than a threshold value for the first verification class to the first verification class;
calculating a performance score of each of the first labels in the first label set for a second verification class; and
mapping labels having performance scores equal to or greater than a threshold value for the second verification class to the second verification class.

10. The method according to claim 4, wherein a label in the first label set which is not mapped to the verification class is excluded when calculating the first performance score.

11. The method according to claim 4, wherein a label in the first label set which is not mapped to the verification class is mapped to a specific verification class having the highest performance score.

12. The method according to claim 1, further comprising, based on the first performance score and the second performance score, which are performance scores standardized in terms of verification classes, quantitatively evaluating a difference in performance between the first image tagging model and the second image tagging model.

13. The method according to claim 1, wherein the first image tagging model and the second image tagging model are trained using different training data.

14. The method according to claim 1, wherein the first image tagging model is associated with a first label set,
the second image tagging model is associated with a second label set, and
the verification class set, the first label set, and the second label set are different from each other.

15. The method according to claim 14, wherein the first label set and the second label set include different numbers of labels from each other.

16. The method according to claim 1, wherein the calculating the first performance score includes:
determining a first label set associated with the first image tagging model;
generating a label-verification class mapping table defining a mapping relationship from the first label set to the verification data set; and
converting an output of the first image tagging model using the label-verification class mapping table.

17. The method according to claim 16, wherein the first performance score and the second performance score are scores standardized in terms of a verification class.

18. The method according to claim 16, wherein the second image tagging model is associated with a second label set, and
the verification class set, the first label set, and the second label set are different from each other.

19. A non-transitory computer-readable recording medium storing instructions that, when executed by one or more processors, cause the one or more processors to perform the method according to claim 1.

20. An information processing system, comprising:
a memory; and
one or more processors connected to the memory and configured to execute one or more computer-readable programs stored in the memory,
wherein the one or more programs include instructions for:
receiving a verification data set including a plurality of verification images and a plurality of correct values associated with the plurality of verification images;
receiving a first image tagging model and a second image tagging model;
calculating a first performance score for the first image tagging model using the verification data set; and
calculate second performance score for the second image tagging model using the verification data set, and
each of the correct values is associated with at least one verification class of a verification class set.
